(19) United States
(12) Patent Application Publication
(10) Pub. No.: US 2010/0257920 A1
(43) Pub. Date: Oct. 14, 2010

(54) CONE PENETROMETERS FOR MEASURING IMPEDANCE OF GROUND

(76) Inventors: Jong-Sub Lee, Gyeonggi-do (KR); Hyung-Koo Yoon, Seoul (KR); Rae Hyun Kim, Seoul (KR); Joon Han Kim, Seoul (KR)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 12/564,127

(22) Filed: Sep. 22, 2009

(30) Foreign Application Priority Data
Apr. 10, 2009 (KR) 10-2009-0031508
Sep. 15, 2009 (KR) 10-2009-0086992

(51) Int. Cl. G01N 3/42

(52) U.S. Cl. 73/84

(57) ABSTRACT

Provided are cone penetrometers for measuring the impedance of the ground. In an embodiment, the cone penetrometer comprises an inner electrode, an outer electrode, an insulator layer and a penetrating rod. The inner electrode includes a cone, a first contact portion to which terminal cables of an impedance meter are connected, and a metal rod. The metal rod has a diameter smaller than that of the cone. The metal rod has a front end connected to the bottom of the cone and a rear end connected to the first contact portion. The outer electrode has an inner diameter smaller than the diameter of the cone and is in the form of a hollow tube accommodating the metal rod. The insulator layer is formed between the inner electrode and the outer electrode to prevent short circuits between the two electrodes. The penetrating rod is in the form of a hollow tube accommodating the outer electrode. The use of the cone penetrometers improves the accuracy and reliability of the measured results. Further, the cone penetrometers can be miniaturized while maintaining high stiffness against buckling.

### CROSS REFERENCE TO RELATED APPLICATIONS

This application claims priority to Korean Patent Application No. 10-2009-0031508, filed Apr. 10, 2009, and Korean Patent Application No. 10-2009-0086992, filed Sep. 15, 2009, both of which are incorporated herein by reference in their entirety.

### BACKGROUND OF THE INVENTION

1. Field of the Invention

The present invention relates to cone penetrometers for measuring the impedance of the ground, and more specifically to cone penetrometers that are designed to measure the impedance of the ground at a tip portion thereof to improve the accuracy and reliability of the measured results, as well as that can be miniaturized while maintaining high stiffness against buckling.

2. Description of the Related Art

Soft ground created as a result of a geographical process of erosion, weathering and deposition over many centuries has various characteristics and structures depending on the conditions where it has been created. Soft ground strata possess inhomogeneity and anisotropicity in horizontal and vertical directions due to the presence of clay layers and thinly layered soils, such as sand seams composed of sand or silt. Thinly layered soils have large differences in water permeability coefficient despite their small thickness of few millimeters, giving a significant effect on the consolidation of soft ground. Accordingly, when it is intended to construct civil engineering and building structures on soft ground, acquisition of highly accurate and reliable parameters of the target ground is a very important task. Thinly layered soils should be detected at the ground investigation stage for rational soft ground design.

In-situ ground investigation refers to an investigation method that is conducted on the actual target ground. Various test methods and apparatuses are currently available. Of these, cone penetration testing is a representative in-situ ground investigation experiment. According to a typical cone penetration test, when a conical probe penetrates the target ground at a constant speed (standard 2 cm/sec), some factors, such as tip resistance (qc), sleeve friction (fs) and pore pressure (u), are measured by the conical probe to determine the properties of the target ground. The advantage of cone penetration testing is that the characteristics of the original ground can be acquired continuously without an additional borehole.

The standard dimensions of a conventional cone penetrometer used for cone penetration testing are a diameter of 35.7 mm and a cross-sectional area of 10 cm². When the conventional cone penetrometer penetrates the target ground, the adjacent ground of the target ground is severely pushed out or pulled in in the direction of the penetration. This phenomenon is called ‘disturbance.’ The disturbance phenomenon causes shear deformation failure of the ground particles and decreases the strength of the original ground, making it difficult to accurately investigate the properties of the target ground. Further, when the conventional cone penetrometer is applied in situ, a large-sized penetration apparatus is needed and penetrating rods must be continuously connected to the conventional cone penetrometer with increasing penetration depth. However, the overall equipment is huge and inconvenient to transport, and further creates a great deal of economic burden. Under such circumstances, there is a rapidly growing need for small cone penetrometers.

On the other hand, electromagnetic survey for ground investigation is a method for measuring a target ground region using artificial signals. The electromagnetic survey is utilized in various applications, including survey of submarine topography, survey of water content variation, survey of soil pollution and facility management. The electromagnetic survey is exemplified by the following methods.

The first method is an electrical resistivity survey in which a potential difference generated when a direct current or a very low-frequency alternating current is sent to the ground is measured to determine the resistivity (i.e. specific resistance) and conductivity of the ground. The electrical resistivity survey has mainly been used to roughly estimate the structure of the ground strata or to identify the presence of pollutants in the strata. The electrical resistivity survey is currently used to estimate the layered structure and design parameters of the ground.

The second method is an induced polarization survey, which is similar to the electrical resistivity survey. According to the induced polarization survey, four electrodes are installed on the ground surface, and a current is sent from one pair of electrodes to the other pair of electrodes and is interrupted to generate a momentary potential difference. The induced polarization survey is mainly used in finding and characterizing metal mines and terrestrial heat.

The third method is a spontaneous potential survey in which a spontaneous potential difference generated between two points on the ground surface is measured to obtain an ideal curve. Based on the ideal curve, the spontaneous potential survey is used in terrestrial heat and hydrogeological investigations.

The fourth method is an electronic survey that uses an electric field and a magnetic field, which are vector quantities perpendicular to each other, to analyze the characteristics of the ground. Unlike the above-mentioned methods, the electronic survey is a non-contact method suitable for use in particular applications, including aircraft and ships. Further, the electronic survey is divided into ground penetration radar (GPR) survey, very low frequency (VLF) survey, etc. taking into consideration the conductivity of targets to be measured. These survey methods are utilized in different applications.

A great advantage of these electromagnetic survey methods, particularly electrical resistivity survey, is in that the state of the ground composed of various composites, such as sand, clay and silt, can be exactly assessed. This advantage is due to the fact that the electromagnetic survey methods have higher sensitivity than other investigation methods. The electrical resistivity of the ground is basically calculated from the measured impedance of the ground. The measured impedance may also be calculated into various parameters (such as potential difference, capacitance, phase angle and permittivity) according to the survey purposes. Therefore, accurate and reliable impedance measurement plays a very important role in ground investigation. Archie proposed an empirical formula for calculating void ratio, a design parameter of soft ground (see Archie, G. E. (1942). “The electrical resistivity log as an aid in determining some reservoir characteristics”, Transactions of the American Institute of Mining, Metallurgical, and Petroleum Engineers, Vol. 146, pp. 54-62). Based on the Archie's proposal, research has been conducted to acquire highly reliable design parameters of the target ground.

A typical cone penetrometer used in the electrical resistivity survey uses a standard cone having a cross-sectional area of 10 cm² and one (single) or two (double) electrodes installed on the upper end of a sleeve (i.e. a penetrating rod) to measure the electrical resistivity of the ground. The cone penetrometer evaluates the characteristics of the target ground at different penetration depths (see Campanella, R. G. and Kokan, M. J. (1993). “A new approach to measuring dilatancy in saturated sands”, Geotechnical Testing Journal, ASTM, Vol. 16, No. 4, pp. 485-495).

However, electrical resistivity survey using a conventional standard cone penetrometer has a problem in that the large diameter of the cone penetrometer induces a disturbance of the ground, as previously explained. This disturbance leads to poor sensitivity of the cone penetrometer, making it difficult to accurately assess the layered structure of the ground. Another problem is that the electrical resistivity of the already disturbed region by the penetration of the cone tip is measured, resulting in low reliability.

Further, another prior art cone penetrometer is known in which an electric resistance type strain gauge or rod cell is mounted within the cone to measure the tip resistance and the sleeve friction against the ground. However, it is difficult to subminiaturize the cone penetrometer due to the internal element. Another problem is that the removal of some measuring sensors is required to subminiaturize the cone penetrometer, making it impossible to measure various properties of the ground.

### SUMMARY OF THE INVENTION

It is, therefore, a first object of the present invention to provide a cone penetrometer that is designed to measure the impedance of the ground at a tip portion thereof to improve the accuracy and reliability of the measured results, as well as that can be miniaturized while maintaining high stiffness against buckling.

It is a second object of the present invention to provide a cone penetrometer that is designed to measure the impedance of the ground at a tip portion thereof and use an optical fiber sensor to improve the accuracy and reliability of the measured results, as well as that can be miniaturized while maintaining high stiffness against buckling.

In order to accomplish the first object of the present invention, there is provided a cone penetrometer for measuring the impedance of the ground, comprising: an inner electrode including a cone, a first contact portion to which terminal cables of an impedance meter are connected, and a metal rod, whose diameter is smaller than that of the cone, having a front end connected to the bottom of the cone and a rear end connected to the first contact portion; an outer electrode, whose inner diameter is smaller than the diameter of the cone, in the form of a hollow tube accommodating the metal rod; an insulator layer formed between the inner electrode and the outer electrode to prevent short circuits between the two electrodes; and a penetrating rod in the form of a hollow tube accommodating the outer electrode.

In an embodiment, the outer electrode has a rear end portion that is in a position corresponding to the first contact portion of the inner electrode and that has a second contact portion to which the other terminal cables of the impedance meter are connected.

In an embodiment, the rear end portion of the outer electrode includes coupling means to which an additional rod is coupled to increase the penetration depth of the cone penetrometer.

In an embodiment, the rear end portion of the outer electrode has a threaded portion onto which the additional rod is screwed.

In an embodiment, the outer electrode has one or more grooves, which are formed on the outer circumference thereof, in which measuring sensors are installed to measure the properties of the ground.

In an embodiment, the outer electrode has stepped portions formed on the outer circumference thereof to support the penetrating rod.

In an embodiment, the outer electrode has a front end portion that is in a position corresponding to the cone of the inner electrode and that has a tapered portion, whose outer diameter decreases toward the cone, protruding from the penetrating rod so as to facilitate the penetration of the penetrating rod.

In an embodiment, the outer electrode includes a front cap coupled to the front end portion thereof to form a stepped portion.

In an embodiment, the front cap of the outer electrode has a tapered portion whose outer diameter decreases toward the cone so as to facilitate the penetration of the penetrating rod.

In an embodiment, the penetrating rod has a portion whose inner diameter is smaller than the inner diameter of a rear end portion of the penetrating rod in a position corresponding to the first contact portion of the inner electrode; and the outer electrode has a support portion that supports the small inner diameter portion of the penetrating rod so as to receive the resultant force of a sleeve friction and a tip resistance from the penetrating rod when the cone penetrometer penetrates the ground.

In an embodiment, the cone penetrometer further comprises, between the outer electrode and the penetrating rod, a first strain gauge for measuring a tip resistance and a second strain gauge for measuring the resultant force of the tip resistance and a sleeve friction when penetrating the ground.

In an embodiment, the first strain gauge is installed between the front end portion of the outer electrode and the support portion; and the second strain gauge is installed between the rear end portion of the outer electrode and the support portion.

In an embodiment, the cone penetrometer has a tapered zone, whose outer diameter decreases toward the cone, between both ends of the penetrating rod.

In order to accomplish the second object of the present invention, there is provided a cone penetrometer for measuring the impedance of the ground, comprising: an inner electrode including a cone, a hollow metal tube, whose outer diameter is smaller than the diameter of the cone, having a front end connected to and closed by the bottom of the cone and an open rear end, and a first contact portion which extends from the open rear end of the metal tube and to which terminal cables of an impedance meter are connected; an outer electrode, whose inner diameter is smaller than the diameter of the cone, in the form of a hollow tube accommodating the metal tube; an insulator layer formed between the inner electrode and the outer electrode to prevent short circuits between the two electrodes; and a penetrating rod in the form of a hollow tube accommodating the outer electrode.

In an embodiment, an optical fiber sensor as a measuring sensor is inserted into the metal tube of the inner electrode to measure the properties of the ground.

In an embodiment, an insulator is filled between the metal tube and the optical fiber sensor.

In an embodiment, the outer electrode has a rear end portion that is in a position corresponding to the first contact portion of the inner electrode and that has a second contact portion to which the other terminal cables of the impedance meter are connected.

In an embodiment, the rear end portion of the outer electrode includes coupling means to which an additional rod is coupled to increase the penetration depth of the cone penetrometer.

In an embodiment, the rear end portion of the outer electrode has a threaded portion onto which the additional rod is screwed.

In an embodiment, the outer electrode has one or more grooves, which are formed on the outer circumference thereof, in which measuring sensors are installed to measure the properties of the ground.

In an embodiment, the outer electrode has stepped portions formed on the outer circumference thereof to support the penetrating rod.

In an embodiment, the outer electrode has a front end portion that is in a position corresponding to the cone of the inner electrode and that has a tapered portion, whose outer diameter decreases toward the cone, protruding from the penetrating rod so as to facilitate the penetration of the penetrating rod.

In an embodiment, the outer electrode includes a front cap coupled to the front end portion thereof to form a stepped portion.

In an embodiment, the front cap of the outer electrode has a tapered portion whose outer diameter decreases toward the cone so as to facilitate the penetration of the penetrating rod.

In an embodiment, the penetrating rod has a portion whose inner diameter is smaller than the inner diameter of a rear end portion of the penetrating rod in a position corresponding to the first contact portion of the inner electrode; and the outer electrode has a support portion that supports the small inner diameter portion of the penetrating rod so as to receive the resultant force of a sleeve friction and a tip resistance from the penetrating rod when the cone penetrometer penetrates the ground.

In an embodiment, the cone penetrometer further comprises, between the outer electrode and the penetrating rod, a first strain gauge for measuring a tip resistance and a second strain gauge for measuring the resultant force of the tip resistance and a sleeve friction when penetrating the ground.

In an embodiment, the first strain gauge is installed between the front end portion of the outer electrode and the support portion; and the second strain gauge is installed between the rear end portion of the outer electrode and the support portion.

In an embodiment, the cone penetrometer has a tapered zone, whose outer diameter decreases toward the cone, between both ends of the penetrating rod.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a view illustrating a cone penetrometer system according to an embodiment of the present invention;

FIG. 2 is a cross-sectional view illustrating a cone penetrometer of the cone penetrometer system of FIG. 1;

FIG. 3 is a cross-sectional view illustrating an inner electrode of the cone penetrometer of FIG. 2;

FIG. 4 is a cross-sectional view illustrating an outer electrode of the cone penetrometer of FIG. 2;

FIG. 5 is a cross-sectional view illustrating a penetrating rod accommodating the outer electrode of FIG. 4;

FIGS. 6a, 6b and 6c are cross-sectional views taken along lines A-A, B-B and C-C of FIG. 2, respectively;

FIG. 7 is a cross-sectional view illustrating a cone penetrometer for measuring the impedance of the ground according to another embodiment of the present invention;

FIG. 8 is a cross-sectional view taken along line D-D of FIG. 7;

FIG. 9 is a cross-sectional view illustrating a cone penetrometer for measuring the impedance of the ground according to another embodiment of the present invention;

FIG. 10 is a cross-sectional view illustrating a cone penetrometer for measuring the impedance of the ground according to another embodiment of the present invention;

FIG. 11 is a cross-sectional view illustrating a penetrating rod of the cone penetrometer of FIG. 10;

FIG. 12 is a cross-sectional view illustrating an outer electrode of the cone penetrometer of FIG. 10;

FIG. 13 is a view illustrating the appearance of the cone penetrometer of FIG. 10 from which the penetrating rod is removed;

FIG. 14 is a photograph showing the actual appearance of a cone penetrometer for measuring the impedance of the ground according to the present invention;

FIG. 15 shows indoor test results of a cone penetrometer according to the present invention; and

FIG. 16 shows field test results of a cone penetrometer according to the present invention.

### DETAILED DESCRIPTION OF THE INVENTION

Preferred embodiments of the present invention will now be described in detail with reference to the accompanying drawings in order to clarify the aspects of the present invention. In describing the present invention, detailed descriptions of related known functions or configurations are omitted in order to avoid making the essential subject of the invention unclear. The terms used herein are defined taking into account their functions and may be varied according to users' and operators' intentions and work practices. Therefore, the terms should be defined based on the disclosure throughout the entire specification.

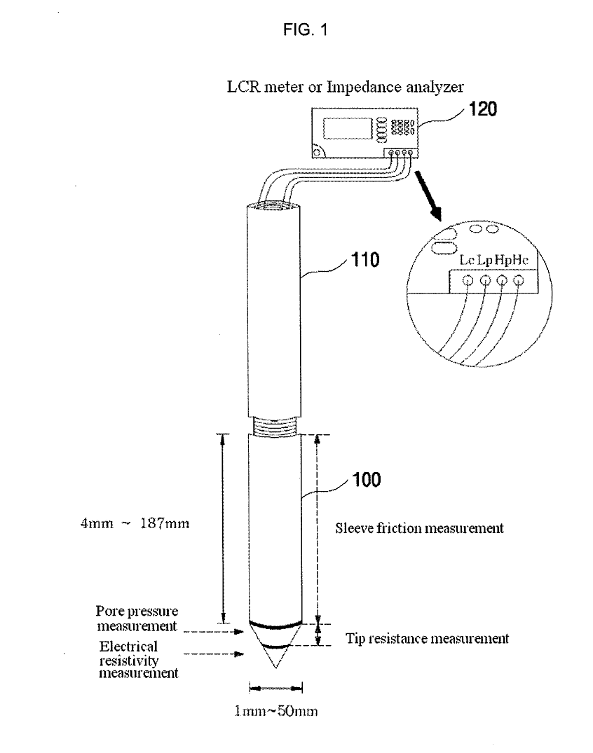

FIG. 1 is a view illustrating a cone penetrometer system according to an embodiment of the present invention.

Referring to FIG. 1, the cone penetrometer system comprises a cone penetrometer 100 for measuring the impedance of the ground, an additional rod 110 and an impedance meter 120.

The cone penetrometer 100 is designed to measure the impedance of the ground at a tip portion thereof, which comes into contact with the target ground at the initial stage of the penetration, to improve the accuracy and reliability of the measured results. Specifically, an impedance sensor is mounted at the tip portion of the cone penetrometer 100 and the diameter of the tip portion of the cone penetrometer 100 can be appropriately adjusted within the range of 1 mm to 50 mm taking into consideration the desired sensitivity and the field conditions. The length of a friction sleeve where the sleeve friction of the cone penetrometer 100 is measured may be determined by the same ratio defined in prior art cone penetrometers (where the ratio of the area of the tip portion to the area of the friction sleeve is 1:15). Further, the cone penetrometer 100 can measure the physical strength characteristics and electromagnetic properties of the target ground simultaneously at the tip portion. That is, the cone penetrometer can be designed so as to enable the measurements of the electrical properties, tip resistance (qc), sleeve friction (fs) and pore pressure (u) of the target ground.

The additional rod 110 serves to increase the penetration depth of the cone penetrometer 100. Cables connected to an outer electrode and an inner electrode of the cone penetrometer 100 escape from the upper end of the additional rod 110 and are connected to the impedance meter 120. The impedance meter 120 may be an LCR meter. In an embodiment, the tip portion of the cone penetrometer 100 may be connected to a circuit of the impedance meter 120 through two pairs of terminals (i.e. a total of four terminals). Although one inner electrode and one outer electrode, i.e. a total of two electrodes, are provided in the cone penetrometer 100, an additional four-terminal electrode may be further connected to the tip portion to acquire stable electrical signals. All ground lines may be connected in the vicinity of the tip portion. In FIG. 1, Hc and Hp represent the current and potential terminals of the inner electrode, respectively, and Lc and Lp represent the current and potential terminals of the outer electrode, respectively.

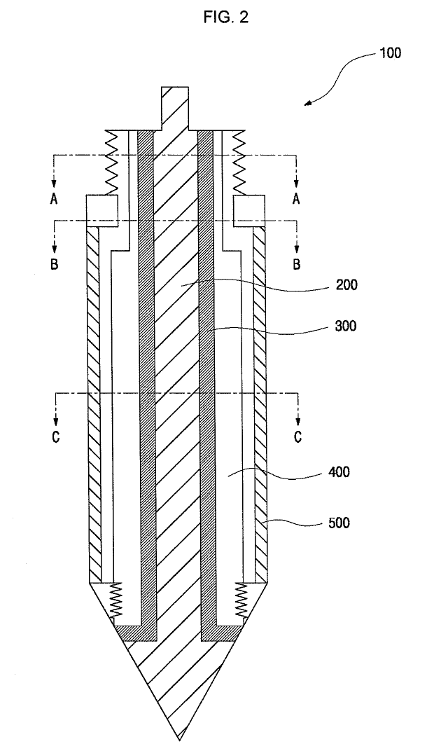

FIG. 2 is a cross-sectional view illustrating the cone penetrometer 100.

Referring to FIG. 2, the cone penetrometer 100 comprises an inner electrode 200, an insulator layer 300, an outer electrode 400, and a penetrating rod 500.

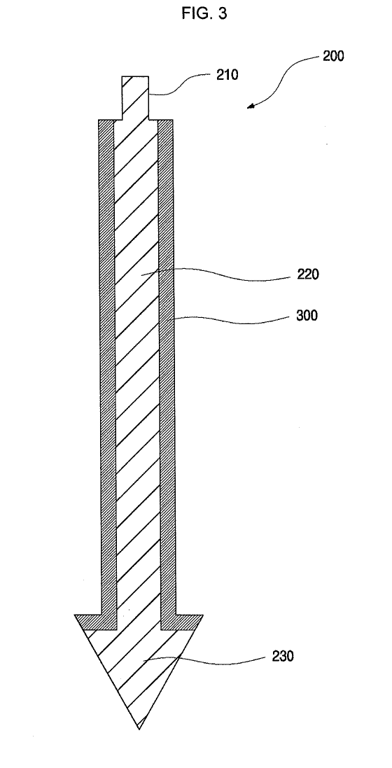

FIG. 3 is a cross-sectional view illustrating the inner electrode 200 of the cone penetrometer 100.

Referring to FIG. 3, the inner electrode 200 includes a cone 230; a first contact portion 210 to which the terminal cables of the impedance meter are connected; and a metal rod 220, whose diameter is smaller than that of the cone 230, having a front end connected to the bottom of the cone 230 and a rear end connected to the first contact portion 210. The insulator layer 300 is formed between and in contact with the inner electrode 200 and the outer electrode 400 to prevent short circuits between the two electrodes. In an embodiment, the insulator layer 300 may be formed of an epoxy resin.

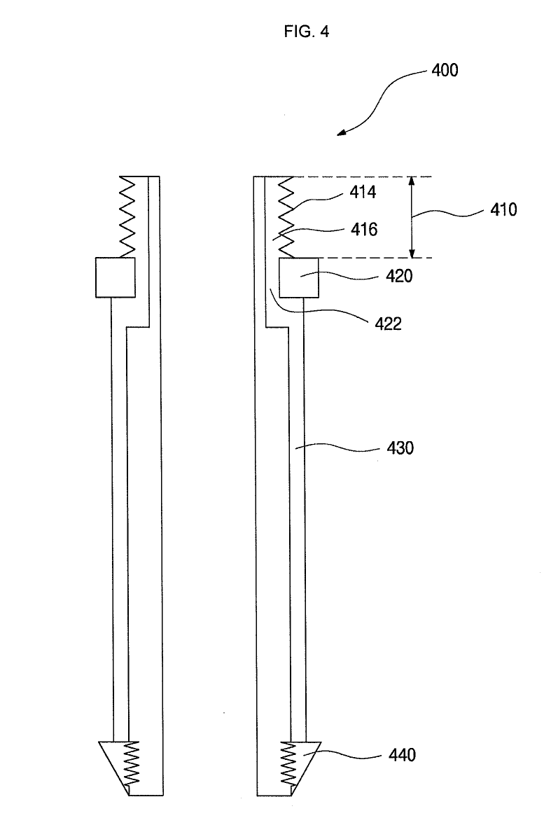

FIG. 4 is a cross-sectional view illustrating the outer electrode 400 of the cone penetrometer 100.

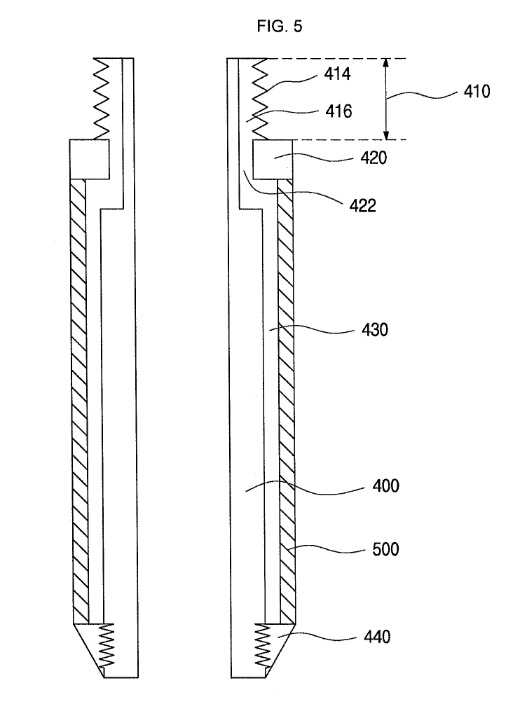

FIG. 5 is a cross-sectional view illustrating the penetrating rod 500 accommodating the outer electrode 400.

Referring to FIGS. 4 and 5, the outer electrode 400 has an inner diameter smaller than the diameter of the cone 230 and is in the form of a hollow tube accommodating the metal rod 220. Both ends of the penetrating rod 500 can be supported by stepped portions 420 and 440 formed on the outer circumference of the outer electrode 400 to accommodate the outer electrode 400 in the penetrating rod 500. One end of the penetrating rod 500 can be supported by a front cap 440 coupled to the front end portion of the outer electrode 400 while forming a stepped portion. The stepped portion of the outer electrode 400 supporting one end of the penetrating rod 500 may protrude from the outer circumference of the front end portion of the outer electrode 400. The reason for the use of the front cap 440 is to facilitate disassembly and assembly of the cone penetrometer 100.

In an embodiment, the front end portion or the front cap 440 of the outer electrode 400 may have a tapered portion 430, whose outer diameter decreases toward the cone 230, protruding from the penetrating rod 500 so as to facilitate the penetration of the penetrating rod 500. Due to the formation of the tapered portion 430, the front end portion or the front cap 440 can facilitate the penetration of the penetrating rod 500 while supporting one end of the penetrating rod 500. As illustrated in FIG. 2, the front end portion or the front cap 440 of the outer electrode 400 may be in a conical shape together with the cone 230.

The outer electrode 400 may have a rear end portion 410 in a position corresponding to the rear end of the metal rod 220. The rear end portion 410 of the outer electrode 400 has a second contact portion (not shown) that protrudes from the penetrating rod 500 when the outer electrode 400 is inserted into the penetrating rod 500. The other terminal cables of the impedance meter 120 are connected to the second contact portion of the outer electrode 400. Further, the rear end portion 410 of the outer electrode 400 may include coupling means to which the additional rod 110 is coupled to increase the penetration depth of the cone penetrometer 100. In an embodiment, the rear end portion 410 of the outer electrode 400 may have a threaded portion 414 onto which the additional rod 110 is screwed. In this embodiment, the threaded portion 414 may be formed with a groove (not shown) though which the other terminal cables of the impedance meter 120 are connected to the outer electrode 400 irrespective of whether or not the additional rod 110 is coupled thereto.

The outer electrode 400 may have grooves 430 in which measuring sensors are installed to measure the properties of the ground. Examples of the measuring sensors include subminiature strain gauges and pore pressure transducers. Various properties of the target ground can be acquired by the measuring sensors. In this case, grooves 416 may be formed at the rear end portion 410 of the outer electrode 400 to safely induce the cables of the measuring sensors to the outside therethrough independently of the coupling of the additional rod 110.

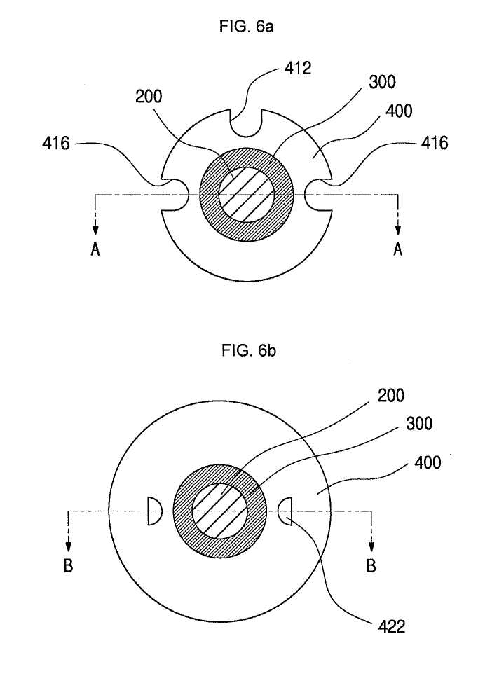

FIGS. 6a, 6b and 6c are cross-sectional views taken along lines A-A, B-B and C-C of FIG. 2, respectively.

As illustrated in FIG. 6a, the rear end portion of the outer electrode 400 may be formed with grooves 416 through which the cables of the measuring sensors, for example, a strain gauge, pass and a groove 412 to which the other terminal cables of the impedance meter 120 are connected.

As illustrated in FIG. 6b, the cables can escape from grooves 422 of the stepped portion 420, which extend from the grooves 430 of the outer electrode 400 in which the measuring sensors are installed.

As illustrated in FIG. 6c, the grooves 430 are formed between the penetrating rod 500 and the outer electrode 400. The measuring sensors are installed in the grooves 430 to measure various properties of the target ground.

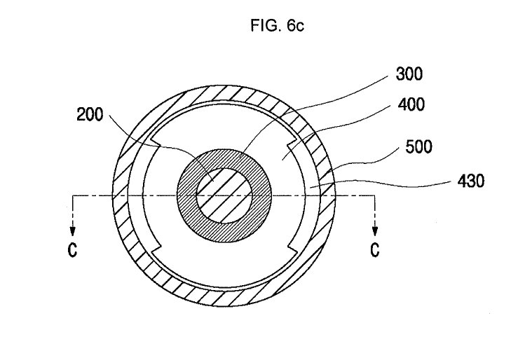

FIG. 7 is a cross-sectional view illustrating a cone penetrometer for measuring the impedance of the ground according to another embodiment of the present invention.

Referring to FIG. 7, the cone penetrometer 100 uses an inner electrode 200 having a different shape from the inner electrode of the cone penetrometer according to the previous embodiment.

Specifically, the inner electrode 200 may include: a cone; a hollow metal tube 240, whose outer diameter is smaller than the diameter of the cone, having a front end connected to and closed by the bottom of the cone and an open rear end; and a first contact portion 210 which extends from the open rear end of the metal tube 240 and to which terminal cables of an impedance meter are connected.

In a particular embodiment, an optical fiber sensor 700 as a measuring sensor may be inserted into the metal tube 240 of the inner electrode 200.

The optical fiber sensor 700 refers to a sensor that uses an optical fiber and measures the intensity of light passing through the optical fiber and changes in the refractive index, length and polarized state of the optical fiber to estimate the parameters of the ground. Such optical fiber sensors are classified into intensity type, phase type, diffraction grating type, mode modulation type, polarization type, distribution measurement type, etc. according to their desired effects of use. Examples of the parameters of the ground to be estimated include voltage, current, temperature, pressure, strain, rotational speed, sound and gas concentration.

Such optical fiber sensors enable ultra-high precision wide-band measurements and facilitate remote measurements. Particularly, the use of the optical fiber sensor 700 in the small-sized cone penetrometer of the present invention can offer many advantages in that electromagnetic waves do not have any influence on the measurements. Further, the optical fiber sensor 700 needs no electricity, and little limitation is imposed on the environment of use of the optical fiber sensor 700 because of good corrosion resistance of the material (e.g., silica) for the optical fiber sensor 700.

In an embodiment, an insulator 710 may be filled between the metal tube 240 of the inner electrode 200 and the optical fiber sensor 700. The insulator 710 may be an epoxy resin.

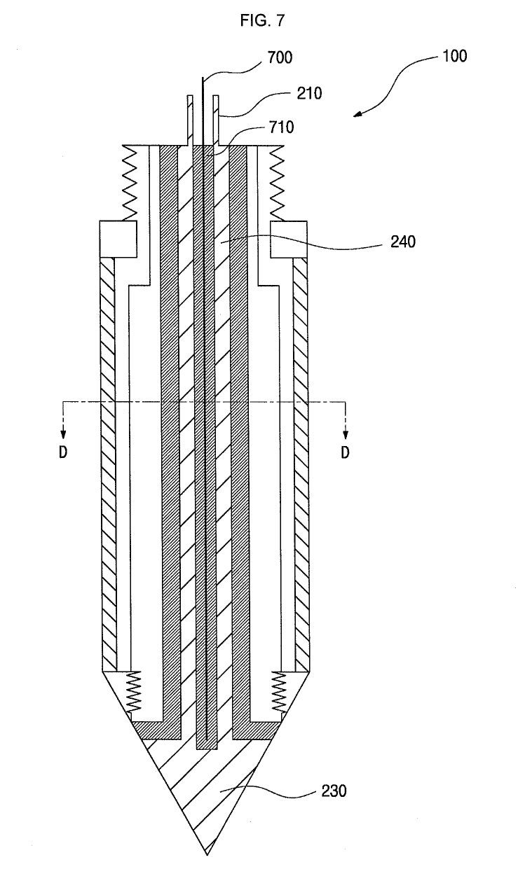

FIG. 8 is a cross-sectional view taken along line D-D of FIG. 7.

As illustrated in FIG. 8, the optical fiber sensor 700 is inserted into the center of the metal tube of the inner electrode 200 and is surrounded by the insulator 710, for example, an epoxy resin.

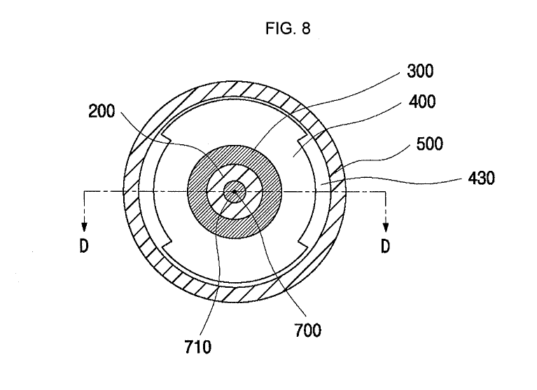

FIG. 9 is a cross-sectional view illustrating a cone penetrometer for measuring the impedance of the ground according to another embodiment of the present invention.

As illustrated in FIG. 9, each of the cone penetrometers of FIGS. 2 and 7 may have a tapered zone 920, whose outer diameter decreases toward the cone, between both ends 910 and 930 of the penetrating rod 500. The reason for the formation of the tapered zone is that the cone penetrometer 100 having an outer diameter as small as 5 mm is protected from being bent or broken by the soil pressure while maintaining high stiffness against buckling when it penetrates the ground to a large depth.

The elements of the cone penetrometers of FIGS. 7 and 9 have the same principles and functions as those of the cone penetrometer of FIG. 2, except for the inner electrode.

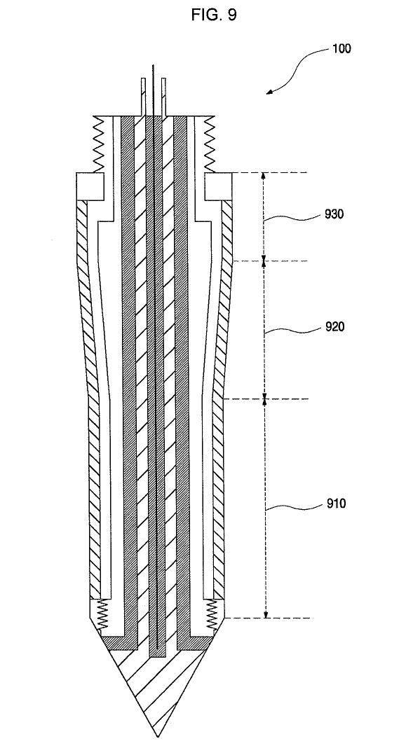

FIG. 10 is a cross-sectional view illustrating a cone penetrometer 100 for measuring the impedance of the ground according to another embodiment of the present invention.

As illustrated in FIG. 10, each of the penetrating rods 500 of the cone penetrometers 100 according to the foregoing embodiments of the present invention (FIGS. 2 and 7) may have a portion 502 whose inner diameter is smaller than that of a rear end portion of the penetrating rod 500 in a position corresponding to the first contact portion 210 of the inner electrode 200.

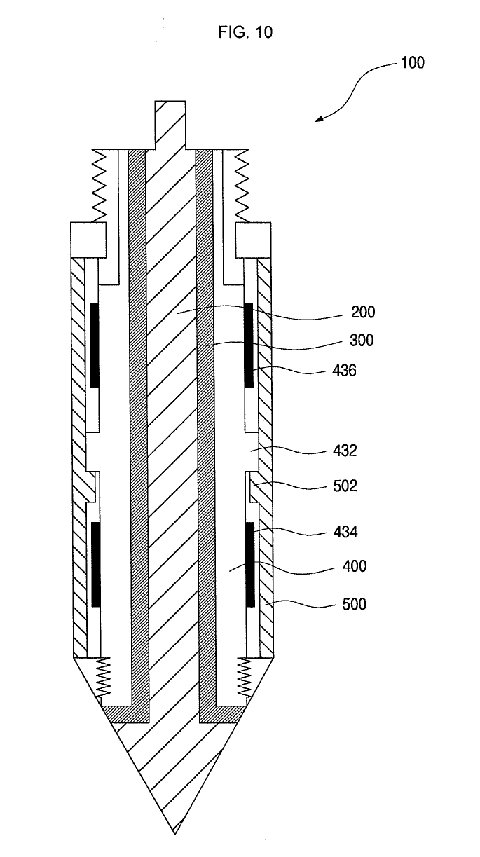

FIG. 11 is a cross-sectional view illustrating the penetrating rod 500 of the cone penetrometer 100 of FIG. 10.

As illustrated in FIG. 11, the portion 502 may have an inner diameter smaller than the inner diameters of both ends of the penetrating rod 500. So long as measuring sensors can be installed between the outer electrode 400 and the penetrating rod 500, the thickness and length of the small inner diameter portion 502 and the state of the inner circumference of the small inner diameter portion 502 may be varied, which will again be explained below.

In this embodiment, the outer electrode 400 has a support portion 432 that supports the small inner diameter portion 502 of the penetrating rod 500 so as to receive the resultant force of a sleeve friction and a tip resistance from the penetrating rod 500 when the cone penetrometer 100 penetrates the ground.

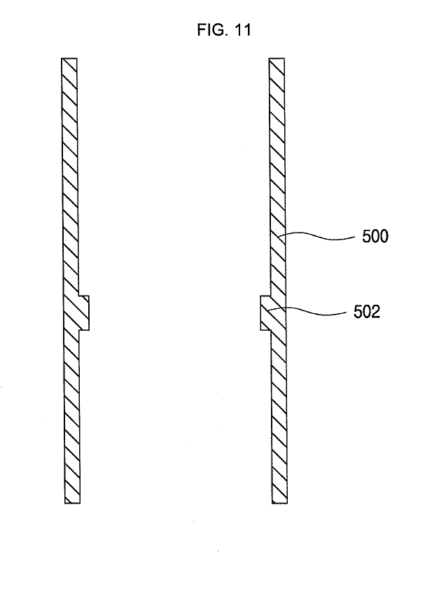

FIG. 12 is a cross-sectional view illustrating the outer electrode 400 of the cone penetrometer 100 of FIG. 10.

As illustrated in FIG. 12, the support portion 432 of the outer electrode 400 may be formed between the stepped portions 420 and 440.

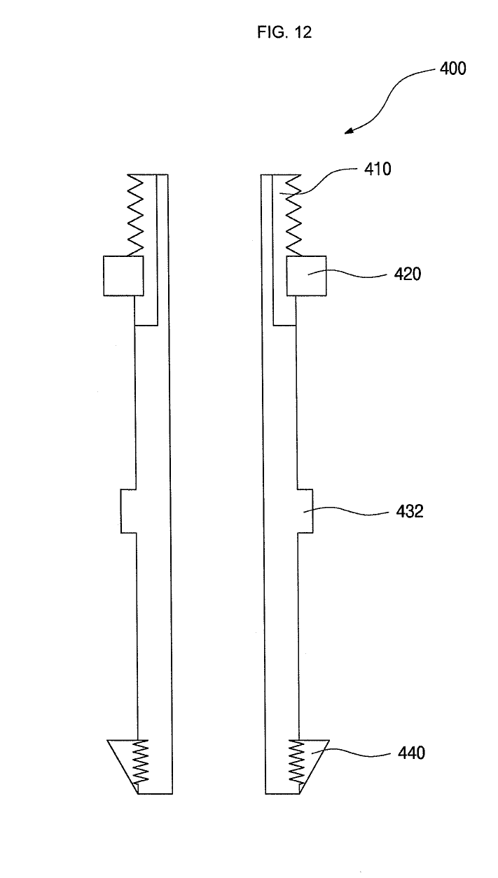

FIG. 13 is a view illustrating the appearance of the cone penetrometer 100 of FIG. 10 from which the penetrating rod 500 is removed.

As illustrated in FIGS. 10 and 13, the cone penetrometer 100 may further comprise measuring sensors 434 and 436 installed between the outer electrode 400 and the penetrating rod 500 to measure the properties of the ground. For example, the measuring sensors 434 and 436 may be a first strain gauge for measuring a tip resistance and a second strain gauge for measuring the resultant force of the tip resistance and a sleeve friction, respectively, when the cone penetrometer 100 penetrates the ground. In this embodiment, the first strain gauge 434 may be installed between the front end portion of the outer electrode 400 and the support portion 432; and the second strain gauge 436 may be installed between the rear end portion of the outer electrode 400 and the support portion 432. The first strain gauge 434 measures a tip resistance sensed through the cone 230 of the inner electrode 200 and the front end portion 440 of the outer electrode 400 when the cone penetrometer 100 penetrates the ground. The second strain gauge 436 measures a tip resistance and a sleeve friction sensed through the support portion 432 from the small inner diameter portion 502 when the cone penetrometer 100 penetrates the ground.

The elements of the cone penetrometer of FIG. 10 have the same principles and functions as those of the cone penetrometer of FIG. 2, except for the outer electrode 400 and the penetrating rod 500.

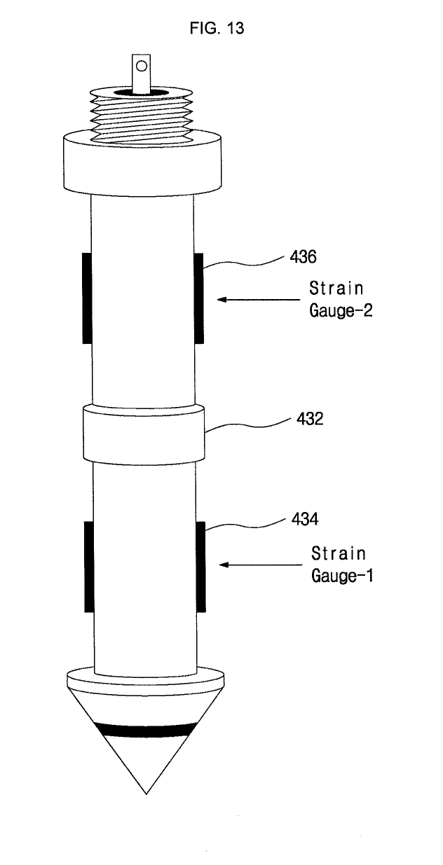

FIG. 14 is a photograph showing the actual appearance of one of the cone penetrometers for measuring the impedance of the ground according to the present invention.

From the appearance of the cone penetrometer of FIG. 14, the insulator layer 300 can be observed between the inner electrode 200 and the outer electrode 400. Particularly, FIG. 14 shows that the cables 414 of the measuring sensors and the terminal cables of the impedance meter can be safely induced through the respective grooves formed at the rear end portion of the outer electrode 400. In addition, the possibility of miniaturization of the cone penetrometer 100 can be easily predicted to be high when compared to the size of the actual object lying around the cone penetrometer 100.

Hereinafter, remarkable effects of the present invention will be discussed.

For a more reliable evaluation, it is necessary to calibrate a measured electric resistance of a material into the specific resistance (i.e. resistivity) of the material. This is because the electrical resistance is varied by the geometric and electrical parameters, e.g., the length and material of electrodes of a probe and the length of cables. There is a linear relationship between the measured electrical resistance and the resistivity. The target ground is evaluated using various linear constants (e.g., slopes) obtained depending on the parameters of the probe. The conductivities of aqueous salt solutions having different concentrations and the resistance value of probe equipment are measured. Based on the measured values, the following equation is given:

R[Ohm]=0.622×ρ (1)

where R is the resistance [Ω] and ρ is the resistivity [Ωcm].

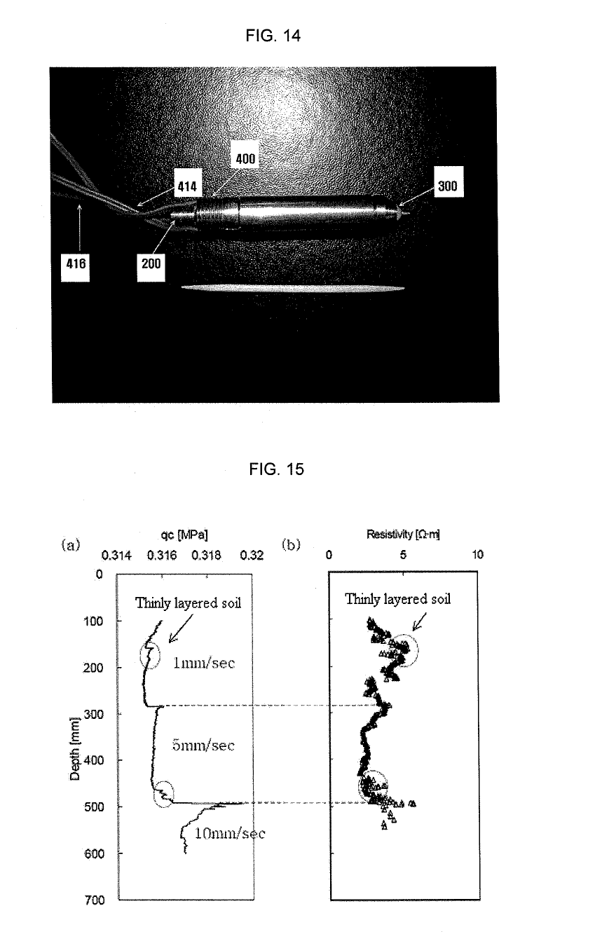

FIG. 15 shows indoor test results of the cone penetrometer according to the present invention.

The applicability of the cone penetrometer was evaluated through an indoor test using a large calibration chamber having an inner diameter of 1.2 m and a height of 1.8 m. After a load was applied to consolidate a sample, a confining pressure of 100 kPa was applied to the consolidated sample during testing to create a confining pressure similar to the field pressure condition. Hydraulic penetration equipment was used to maintain the penetration of the cone penetrometer at an accurate speed. The cone penetrometer penetrated the sample up to 60 cm taking into consideration the boundary confinement effect. The penetration was continuously carried out to measure the characteristics of the sample. Specifically, the cone penetrometer penetrated the sample at different speeds depending on the depth in order to evaluate the influence of the penetration speed on the performance of the cone penetrometer. The penetration speed was maintained at 1 mm/sec at the initial stage and was increased to 5 mm/sec and 10 mm/sec at depths of 30 cm and 50 cm, respectively.

The electrical resistivity values of the sample were determined using slopes obtained from the measured electrical resistance values and the calibration equation (FIG. 15). It can be confirmed from FIG. 15 that the resistivity was increased in the zones where the penetration speed was increased and thinly layered soils were present, similarly to the tip resistance. Particularly, a sharp increase in electrical resistivity was observed in the regions where thinly layered soils were present.

These results reveal a very high sensitivity of the cone penetrometer to electrical resistivity and also suggest that the complementary measurement of the electrical resistivity and the tip resistance will help to survey thinly layered soils and understand the strength characteristics of the target ground.

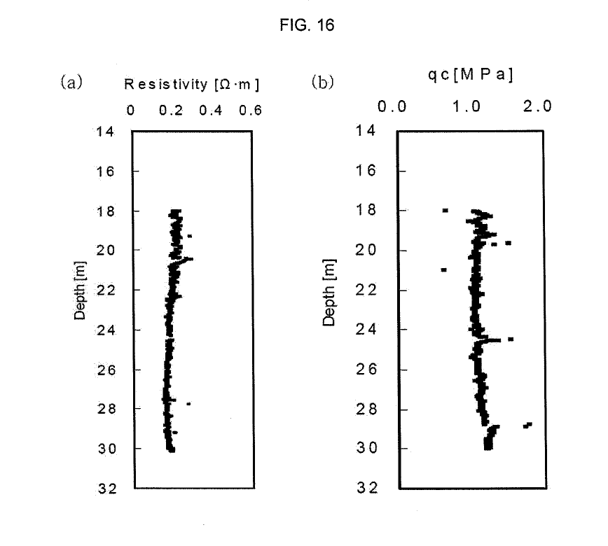

FIG. 16 shows field test results of the cone penetrometer according to the present invention.

The relationship was determined between the cone tip bearing capacity of the cone penetrometer and the electrical resistivity of the target ground, which were measured independently of each other, to evaluate the field test results of the cone penetrometer. The field tests were conducted at Hwajeon District, Busan, Korea. The target ground was composed of sand layers up to about 10 m below the ground surface and silty clay layers between about 10 cm and about 30 m deep below the ground surface. A hydraulic drill was used to facilitate the penetration of the cone penetrometer to a large depth. The measured data were automatically stored in an LCR meter and a computer.

As illustrated in FIG. 16, the tip resistance increased with increasing depth, indicating that the lower structure was composed of harder soil layers than the upper structure. According to the research results of Archie (1942), the electrical resistivity values measured at different depths indicate a decrease in void ratio, suggesting that the soil layers tend to be harder with increasing depth. This tendency is similar to that of the standard cone penetration test results. That is, the tip bearing capacity representing the strength characteristics of the cone penetrometer is not independent of the electrical resistivity representing the electrical properties of the ground, suggesting that highly reliable analysis of the ground can be achieved by collectively considering the test results for the tip bearing capacity and the electrical resistivity.

According to the present invention, accurate data regarding undisturbed regions of the ground can be acquired using the impedance sensor installed at the tip portion of the cone penetrometer to plot a boring log. Therefore, it is expected that the cone penetrometer of the present invention will be efficiently used in the evaluation of the uncertainty and complexity (for example, thinly layered soils) of the ground. Further, data on tip resistance, sleeve friction and pore pressure measured simultaneously by the cone penetrometer can be utilized in a complementary manner. Further, various properties of the ground can be estimated through a one-time in-situ test using the cone penetrometer, which is economically advantageous. Therefore, it is anticipated that there will be a great demand for the cone penetrometer of the present invention in the ground investigation.

As is apparent from the above description, each of the cone penetrometers according to the preferred embodiments of the present invention is designed to measure the impedance of the ground at a tip portion thereof, which comes into contact with the target ground at the initial stage of the penetration, to improve the accuracy and reliability of the measured results. In addition, the cone penetrometers can be miniaturized while maintaining high stiffness against buckling due to their multi-tubular structure, and can measure various properties (including impedance) of the ground. Furthermore, each of the cone penetrometers is designed to use an optical fiber sensor as a measuring sensor. This design enables the subminiaturization of the cone penetrometers and can reduce plastic strain and disturbance regions as much as possible to acquire a ground parameter close to the strength of the original ground.

The cone penetrometers according to the embodiments of the present invention offer the following advantages.

Firstly, the impedance of the target ground can be measured at a tip portion, which comes into contact with the ground at the initial stage of the penetration, of each of the cone penetrometers to improve the accuracy and reliability of the measured results.

Secondly, the cone penetrometers can be miniaturized while maintaining high stiffness against buckling due to their multi-tubular structure, and can measure various properties (including impedance) of the ground.

Thirdly, subminiaturization of the cone penetrometers can be achieved by the use of an optical fiber sensor as a measuring sensor. Therefore, when the subminiature cone penetrometers penetrate the ground, plastic strain and disturbance regions can be reduced as much as possible to acquire a ground parameter close to the strength of the original ground.

Although the present invention has been described herein with reference to the foregoing embodiments, those skilled in the art will appreciate that various modifications are possible, without departing from the spirit of the present invention. Therefore, the embodiments serve to illustrate the nature of the invention and they should not be considered in the limiting sense thereof. Thus, the true scope of the present invention should be defined by the appended claims, and all changes which come within the meaning and range of equivalency of the claims should be construed as falling within the scope of the invention.

What is claimed is:

1. A cone penetrometer for measuring the impedance of the ground, comprising:
an inner electrode including a cone, a first contact portion to which terminal cables of an impedance meter are connected, and a metal rod, whose diameter is smaller than that of the cone, having a front end connected to the bottom of the cone and a rear end connected to the first contact portion;
an outer electrode, whose inner diameter is smaller than the diameter of the cone, in the form of a hollow tube accommodating the metal rod;
an insulator layer formed between the inner electrode and the outer electrode to prevent short circuits between the two electrodes; and
a penetrating rod in the form of a hollow tube accommodating the outer electrode.

2. A cone penetrometer for measuring the impedance of the ground, comprising:
an inner electrode including a cone, a hollow metal tube, whose outer diameter is smaller than that of the cone, having a front end connected to and closed by the bottom of the cone and an open rear end, and a first contact portion which extends from the open rear end of the metal tube and to which terminal cables of an impedance meter are connected;
an outer electrode, whose inner diameter is smaller than the diameter of the cone, in the form of a hollow tube accommodating the metal tube;
an insulator layer formed between the inner electrode and the outer electrode to prevent short circuits between the two electrodes; and
a penetrating rod in the form of a hollow tube accommodating the outer electrode.

3. The cone penetrometer of claim 2, wherein an optical fiber sensor as a measuring sensor is inserted into the metal tube of the inner electrode to measure the properties of the ground.

4. The cone penetrometer of claim 3, wherein an insulator is filled between the metal tube and the optical fiber sensor.

5. The cone penetrometer of claim 1, wherein the outer electrode has a rear end portion that is in a position corresponding to the first contact portion of the inner electrode and that has a second contact portion to which the other terminal cables of the impedance meter are connected.

6. The cone penetrometer of claim 5, wherein the rear end portion of the outer electrode includes coupling means to which an additional rod is coupled to increase the penetration depth of the cone penetrometer.

7. The cone penetrometer of claim 6, wherein the rear end portion of the outer electrode has a threaded portion onto which the additional rod is screwed.

8. The cone penetrometer of claim 1, wherein the outer electrode has one or more grooves, which are formed on the outer circumference thereof, in which measuring sensors are installed to measure the properties of the ground.

9. The cone penetrometer of claim 1, wherein the outer electrode has stepped portions formed on the outer circumference thereof to support the penetrating rod.

10. The cone penetrometer of claim 9, wherein the outer electrode has a front end portion that is in a position corresponding to the cone of the inner electrode and that has a tapered portion, whose outer diameter decreases toward the cone, protruding from the penetrating rod so as to facilitate the penetration of the penetrating rod.

11. The cone penetrometer of claim 9, wherein the outer electrode includes a front cap coupled to the front end portion thereof to form a stepped portion.

12. The cone penetrometer of claim 11, wherein the front cap of the outer electrode has a tapered portion whose outer diameter decreases toward the cone so as to facilitate the penetration of the penetrating rod.

13. The cone penetrometer of claim 9, wherein the penetrating rod has a portion whose inner diameter is smaller than the inner diameter of a rear end portion of the penetrating rod in a position corresponding to the first contact portion of the inner electrode; and the outer electrode has a support portion that supports the small inner diameter portion of the penetrating rod so as to receive the resultant force of a sleeve friction and a tip resistance from the penetrating rod when the cone penetrometer penetrates the ground.

14. The cone penetrometer of claim 13, further comprising, between the outer electrode and the penetrating rod, a first strain gauge for measuring a tip resistance and a second strain gauge for measuring the resultant force of the tip resistance and a sleeve friction when penetrating the ground.

15. The cone penetrometer of claim 14, wherein the first strain gauge is installed between the front end portion of the outer electrode and the support portion; and the second strain gauge is installed between the rear end portion of the outer electrode and the support portion.

16. The cone penetrometer of claim 1, wherein the cone penetrometer has a tapered zone, whose outer diameter decreases toward the cone, between both ends of the penetrating rod.
